(19) United States
(12) Patent Application Publication
(10) Pub. No.: US 2004/0022688 A1
(43) Pub. Date: Feb. 5, 2004

(54) Means for attaching pipettes to ancillary equipment

(76) Inventor: Miles Blackwood, Buderim (AU)

Correspondence Address: MILES BLACKWOOD, 3 FLINT COURT, BUDERIM, 4556, AU

(21) Appl. No.: 10/436,035

(22) Filed: May 8, 2003

(30) Foreign Application Priority Data
May 13, 2002 (AU) PS2235

(51) Int. Cl. B01L 3/02

(52) U.S. Cl. 422/100

(57) ABSTRACT

A means of attaching pipettes to ancillary equipment is provided in which the forces required for attaching the pipette are rotational so that the user is less likely to sustain injury if the pipette breaks.

### FIELD OF THE INVENTION

This invention relates to means for attaching pipettes to ancillary equipment.

### BACKGROUND OF THE INVENTION

Pipettes used in laboratories are often made of glass and are generally long and slender and consequently break easily.

Pipettes are often operated in conjunction with a pipette controller provided with a socket into which the pipette is inserted to make a temporary attachment. So attached, the pipette controller can be operated to control the liquid level inside the pipette, but the temporary attachment means must also provide a seal between the outer walls of the pipette and the atmosphere outside the controller. The seal is an essential requirement to ensure the correct and safe operation of the controller. If a seal is not provided, air can enter the upper end of the pipette, thus breaking the hydraulic lock within the pipette allowing liquid in the pipette to flow out the lower end of the pipette.

In one controller design, a tapered socket is provided so that the pipette is held in position by the friction between the pipette and the tapered walls of the aperture, the said taper also forming a seal around the pipette. In another design, the pipette is inserted into a socket the diameter of which may be adjusted by mechanical means.

In all cases the insertion of the pipette into the socket requires the operator to apply pressure parallel to the long axis of the pipette, to push it into the socket so that it is retained and sealed.

However the walls of the socket become worn and may fail to retain the pipette and/or provide a seal. Even in a correctly fitting pipette/controller combination of the known types the pipette wobbles in the joint so that it is difficult to differentiate between a poorly fitting assembly and a secure assembly. This uncertainty results in users thinking a connection is secure when it is not, with the consequence that the pipette sometimes falls out of the controller in mid-use. This is a safety problem concerning glass and plastic pipettes. In an attempt to rectify the malfunctioning controller the operator is inclined to push the pipette harder into the controller in an effort to obtain a seal or fix the pipette more securely into the controller. If the pipette breaks while the pressure is being exerted, the momentum of the hand is towards the broken end of the pipette that is protruding from the controlling device. This results in piercing injuries and is a common cause of accidents in laboratories, mainly concerning glass pipettes.

It is noted that heavy-handed operators may also break pipettes while inserting them into controllers even when the controllers are functioning correctly.

### SUMMARY OF THE INVENTION

According to one aspect of the present invention there is provided a pipette comprising a tube with a dispensing nozzle at one end and a screw thread adjacent the other end wherein a rotational force applied perpendicular to the long axis of the pipette can connect the screw thread to a reciprocal thread in an ancillary device.

This aspect of the invention therefore provides a more reliable attaching means for pipettes and an arrangement in which the force applied to attach the pipette to ancillary devices is less likely to result in injury.

According to another aspect of the invention there is provided a pipette comprising a tube with a dispensing nozzle at one end and a screw thread adjacent the other end in which the thread is provided by an attachable means.

According to another aspect of the invention there is provided a method of attaching a pipette comprising a tube with a dispensing nozzle at one end and an attaching means adjacent the other end to an ancillary device provided with a reciprocal attaching means, the method consisting of applying a rotational force to the attaching means of the pipette such that the pipette is release ably attached to the ancillary device.

### BRIEF DESCRIPTION OF THE DRAWINGS

Specific embodiments of the invention will now be described by way of example with reference to the accompanying drawings, in which:

FIG. 1 shows in perspective a pipette [1] with an attached thread [4].

FIG. 2 shows in perspective a known pipette being assembled to an ancillary device [8] with a pushing motion [9].

FIG. 2B shows, by comparison, an embodiment of the invention being assembled to the handpiece [8] with a rotating motion [10].

### DETAILED DESCRIPTION

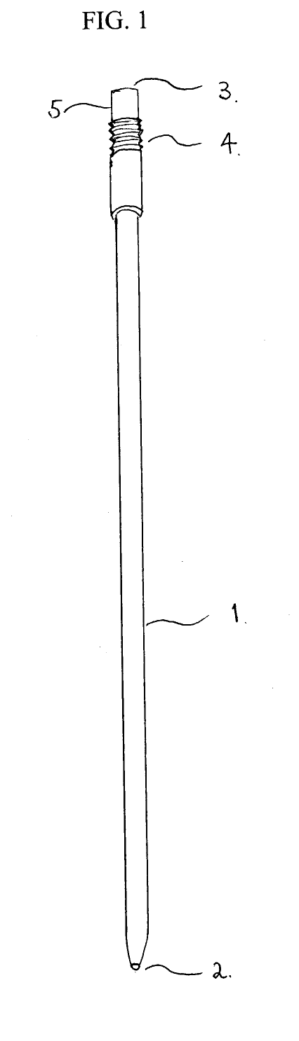

Referring to the drawings, FIG. 1 shows the pipette comprised of a tube [1], a nozzle at one end [2], an open end [3], and the threaded section [4] assembled onto the tube [1]. The threaded section [4] may be provided in the form of a plastic attachment and additionally may have a section [5] sized to fit known pipette controlling devices. Some designs of ancillary equipment will require that the thread [4] or another feature at a convenient location towards the open end of the pipette [3] be constructed so as to form a seal between the interior of the pipette and the free atmosphere when connected to said ancillary equipment.

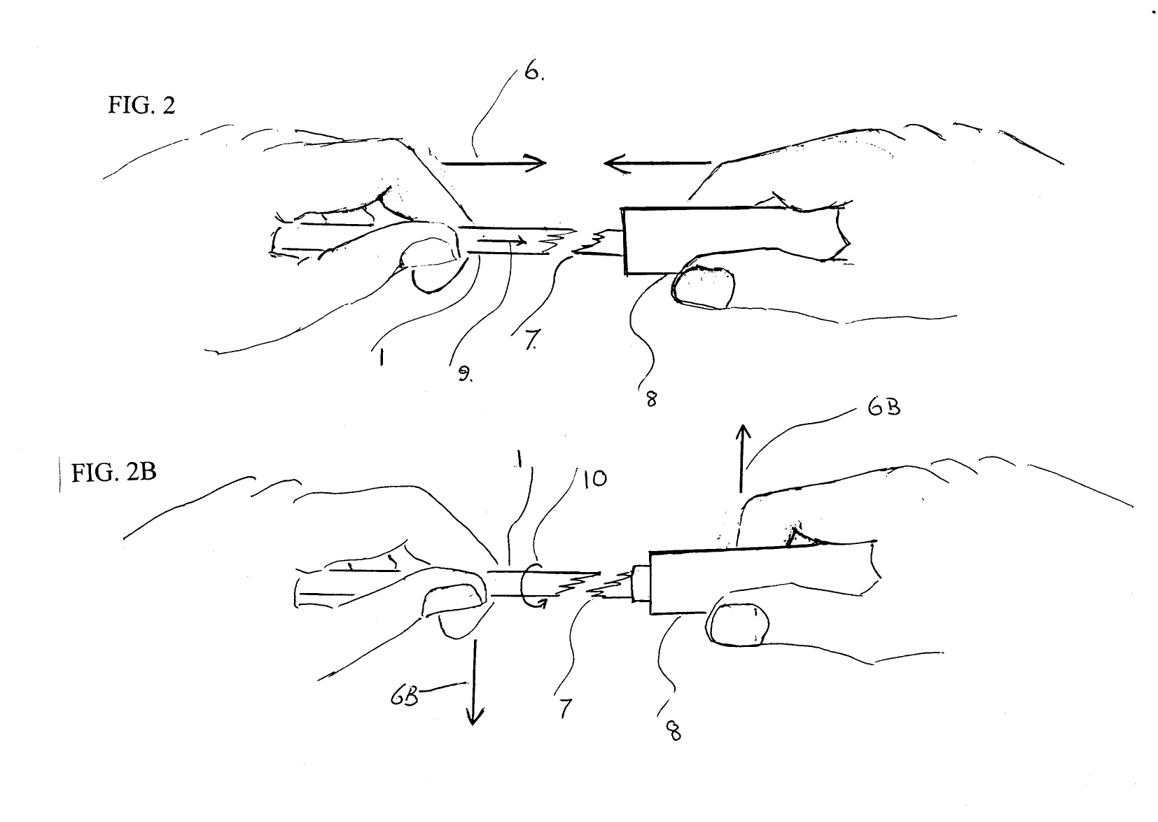

FIG. 2 shows that the momentum of the hand [6] carries it towards the broken edge of the pipette tube [7] if the pipette tube [1] is broken while assembling it with a pushing motion [9] to the ancillary device [8]

FIG. 2B shows that the momentum of the hand [6B] carries it away from the broken edge of the pipette tube [7] if the pipette tube [1] is broken while assembling it with a rotating motion [10] to the ancillary device [8]. It will be appreciated that the attaching method may be any means that requires a rotational motion into a reciprocal means.

I claim:

1. A pipette comprising a tube with a dispensing nozzle at one end and a screw thread adjacent the other end wherein a rotational force applied perpendicular to the long axis of the pipette can connect the screw thread to a reciprocal thread in an ancillary device.

2. A pipette comprising a tube with a dispensing nozzle at one end and a screw thread adjacent the other end in which the thread is provided by an attachable means.

3. A method of attaching a pipette comprising a tube with a dispensing nozzle at one end, and an attaching means adjacent the other end, to an ancillary device provided with a reciprocal attaching means, the method consisting of applying a rotational force to the attaching means of the pipette such that the pipette is removably attached to the ancillary device.
